(19) United States
(12) Patent Application Publication
(10) Pub. No.: US 2026/0253341 A1
(43) Pub. Date: Aug. 27, 2026

(54) APPARATUS FOR EXTENDED REALITY APPLICATIONS AND METHOD OF ASSEMBLING THE APPARATUS

(71) Applicant: Dispelix Oy, Espoo (FI)

(72) Inventors: Mikhail OMELYANOVICH, Espoo (FI); Juuso OLKKONEN, Espoo (FI); Klas ANDERSSON, Espoo (FI); Petri STENBERG, Espoo (FI); Janne LAUKKANEN, Espoo (FI); Ville KONTTUR, Espoo (FI)

(21) Appl. No.: 19/062,201

(22) Filed: Feb. 25, 2025

(51) Int. Cl. G06T 19/00; G02B 27/01

(52) U.S. Cl. CPC G06T 19/006; G02B 27/0172; G02B 2027/0178

(57) ABSTRACT

An apparatus for extended reality applications and a method of assembling the apparatus, such as a see-through display device, comprising a first cover (320), a second cover (330), and an optical waveguide (140) attached in between the first cover (320) and the second cover (330), wherein the first cover (320) and the second cover (330) are in physical contact with the optical waveguide (140) at respective contact regions, but an air gap (350) is still maintained at said respective contact regions by surface morphology.

### FIELD

The present disclosure generally relates to see-through display devices.

### BACKGROUND

This section illustrates useful background information without admission of any technique described herein representative of the state of the art.

In see-through display devices, such as in devices for extended reality (XR) applications, transparent waveguide combiners may be used as see-through displays to optically combine real and virtual worlds in a user's field of vision.

In such devices light from a light engine typically enters the waveguide combiner via a light in-coupling section, propagates within the waveguide combiner by total internal reflection, and exits the waveguide combiner via a light out-coupling section typically also comprising an exit pupil expander (EPE) conveniently expanding the output light for a pupil of an eye of a user.

The see-through display devices may contain prescription lenses provided as a cover around the waveguide of the waveguide combiner. For proper functioning of the waveguide, e.g., to support total internal reflection, an optical insulation layer should be used to optically insulate the waveguide from the cover. Optical insulation can be achieved by a low refractive index layer or by an air gap. The low refractive index layer the maximum field of view (FOV) that can be transferred through the waveguide, so it would be preferable to provide optical insulation through the use of an air gap. A conventional way to provide an air gap is to create an air gap by spacers. This will, however, increase the size of the waveguide combiner.

### SUMMARY

It is an object of certain embodiments of the present disclosure to reduce complexity of apparatuses for extended reality applications or at least to provide an alternative solution to existing technology.

According to a first example aspect of the present disclosure there is provided an apparatus for extended reality applications, comprising:
a first cover;
a second cover; and
an optical waveguide attached in between the first cover and the second cover, wherein the first cover and the second cover are in physical contact with the optical waveguide at respective contact regions, but an air gap is still maintained at said respective contact regions by surface morphology.

In certain embodiments, the air gap comprises trapped air. In certain embodiments, the air gap comprises air trapped in between the optical waveguide and a respective cover. In certain embodiments, the air gap comprises air trapped in between the optical waveguide and a respective cover due to sealing. In certain embodiments, the air gap comprises air trapped in between the optical waveguide and a respective cover due to air-tight sealing along a peripheral outline of the waveguide. In certain embodiments, said air-tight sealing is effected prior to assembling (putting together) the apparatus by using external pressure (i.e., prior to molding or casting). In certain embodiments, the apparatus comprises a pre-attached seal attached prior to assembling (putting together) the apparatus by molding or casting. In certain embodiments, the apparatus comprises an air-tight sealing along a peripheral outline of the waveguide to prevent air from escaping from said air gap (during a manufacturing process, such as molding or casting). In certain embodiments, the apparatus comprises an air-tight sealing along a peripheral outline of the waveguide to prevent an optical contact from being formed between the optical waveguide and a respective cover.

In certain embodiments, there is an air gap in between the optical waveguide and the first cover. In certain embodiments, there is an air gap in between the optical waveguide and the second cover. In certain embodiments, the air gap(s) are within a sealed volume. In certain embodiments, air is trapped within the sealed volume. In certain embodiments, the apparatus is configured to optically insulate the optical waveguide from a cover (i.e., the first and/or the second cover). In certain embodiments, the apparatus is configured to optically insulate the optical waveguide from a cover by a structural feature of the apparatus comprising the optical waveguide being in physical contact with the (respective) cover but having air trapped in between the optical waveguide and the cover (so as to prevent an optical contact from being formed in between the optical waveguide and the cover).

In certain embodiments, the air gap is arranged to optically insulate the optical waveguide from the first cover and from the second cover.

Advantageously, an air gap is maintained without a spacer (or spacers). In certain embodiments, the air gap is maintained by the optical waveguide and a respective (first or second) cover touching each other at the contact region with point-like contacts only. In certain embodiment, the contact region is a continuous region extending throughout a respective waveguide surface. In certain embodiments, the contact region spreads out to the whole interface between the waveguide surface and surface of the respective cover. In certain embodiments, said maintaining an air gap is caused by intended surface imperfections (designed surface morphology). In certain embodiments, said maintaining an air gap is caused by surface imperfections or non-idealities (physical imperfections or non-idealities of the surface) of the respective cover.

In certain embodiments, the first and/or second cover comprises an anti-reflection coating facing towards the optical waveguide.

In certain embodiments, both the first and second cover comprise an anti-reflection coating facing towards the optical waveguide.

In certain embodiments, the apparatus comprises an interface between the optical waveguide and the first and/or second cover sealed along a peripheral outline of the optical waveguide (prior to a molding or casting manufacturing stage).

In certain embodiments, both interfaces between the optical waveguide and the first and second cover are, respectively, sealed along peripheral outlines of the optical waveguide.

In certain embodiments, the interface(s) is/are sealed in a dust-proof manner. In certain embodiments, the interface(s) is/are sealed in a liquid-proof manner. In certain embodiments, the interface(s) is/are sealed in an airtight manner. In certain embodiments, the interface is sealed with a hermetic seal. Accordingly, in certain embodiments the apparatus comprises an arrangement or structure preventing air (together with dust, humidity, etc.) from entering the air gaps from outside of the apparatus (and, similarly, prevents air from escaping from the air gaps).

In certain embodiments, said sealing is realized by applying a glue or an adhesive.

In certain embodiments, said sealing is realized by applying a sealing tape.

In certain embodiments, the apparatus is assembled (put together) by molding or casting, such as low pressure casting. Accordingly, in certain embodiments, the apparatus comprising the first cover, the second cover, and the optical waveguide forms a molded or casted structure.

In certain embodiments, the apparatus comprises refractive index of casting resin matched with refractive index of the first and second cover.

In certain embodiments, the first and/or second cover further comprises at least one of a prescription lens, a dust-cover film, a dimming film, a push-pull addition.

In certain embodiments, the apparatus comprises an in-coupling grating at a light in-coupling section of the apparatus.

In certain embodiments, the apparatus further comprises a light out-coupling section and/or a light expanding section.

In certain embodiments, the apparatus is a see-through display device.

According to a second example aspect of the present disclosure there is provided a method of assembling the apparatus of any preceding claim from parts, comprising: positioning an optical waveguide in between a first cover and a second cover so that the first cover and the second cover are in physical contact with the optical waveguide at respective contact regions, but an air gap is still maintained at said respective contact regions by surface morphology; and
attaching parts together by molding or casting.

In certain embodiments, the method further comprises:
coating an anti-reflection coating onto a surface of the first and second cover; and
placing the first and second cover so that the anti-reflection coating faces towards the optical waveguide.

In certain embodiments, the method comprises:
sealing interfaces between the optical waveguide and the first and second cover along peripheral outlines of the optical waveguide prior to said molding or casting.

Different non-binding example aspects and embodiments have been illustrated in the foregoing. The above embodiments are used merely to explain selected aspects or steps that may be utilized in implementations of the present disclosure. Some embodiments may be presented only with reference to certain example aspects. It should be appreciated that corresponding embodiments apply to other example aspects as well. In particular, the embodiments described in the context of the first aspect are applicable to each further aspect, and vice versa. Any appropriate combinations of the embodiments may be formed.

### BRIEF DESCRIPTION OF THE DRAWINGS

The present disclosure will now be described, by way of example only, with reference to the accompanying drawings, in which:

FIG. 1 shows an example of a see-through display device in accordance with certain embodiments;

FIG. 2 shows a waveguide combiner in accordance with certain embodiments;

FIG. 3 shows a schematic cross-sectional view of an apparatus in accordance with certain embodiments;

FIG. 4 shows a more detailed schematic cross-sectional view of an apparatus in accordance with certain embodiments; and

FIG. 5 shows a flow chart in accordance with certain embodiments.

### DETAILED DESCRIPTION

In the following description, like reference signs denote like elements or steps.

In certain embodiments, it has been concluded that for proper functioning of diffractive waveguides it is preferable to maintain an air gap between a waveguide and a cover, such as a prescription lens, to maintain proper conditions for total internal reflection (TIR) and to enable maximization of the field of view (FOV).

Further, it has been observed that simply putting two solid materials together into contact would allow to have the required air gap without use of any spacers. It has been observed that the required gap can be obtained by physical imperfections of the surfaces in question.

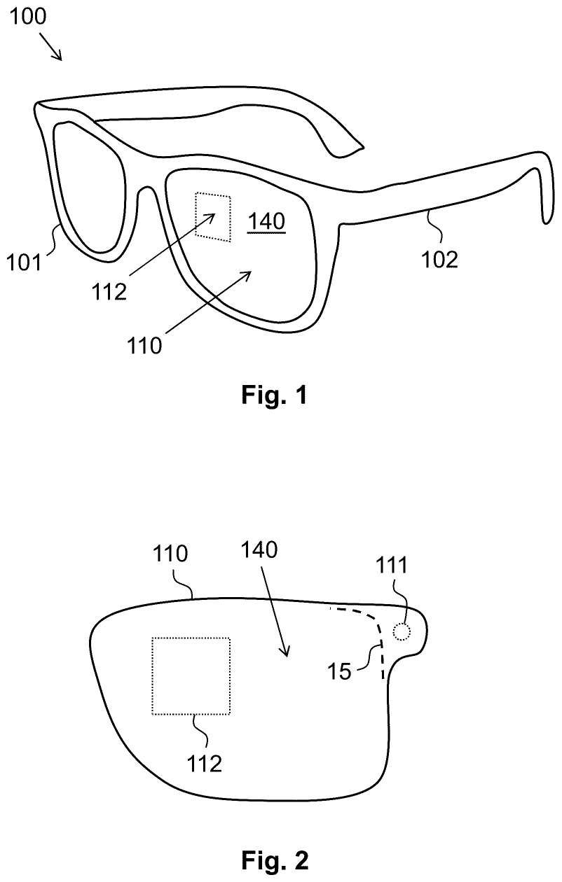

FIG. 1 shows an example of a see-through display device 100 in accordance with certain embodiments. The see-through display device 100 comprises a waveguide combiner 110 to optically combine real and virtual worlds in a user's field of vision. The see through display device 100 may be a near-to-eye display device, such as extended reality (XR) glasses. The waveguide combiner 110 comprises an optical waveguide 140. Light trapped into the optical waveguide 140 exits from the optical waveguide 140 via an out-coupling section 112. In certain embodiments, the optical waveguide 140 is of transparent material (to visible light). In certain embodiments, the optical waveguide 140 is a single layer waveguide. In certain embodiments, the optical waveguide 140 is an essentially planar or two-dimensional waveguide. The term planar or two-dimensional is used herein to distinguish from optical fibers or other tubular waveguides. Therefore, the essentially planar or two-dimensional waveguide herein may be curved such as a lens of glasses (prescription lens) or a visor of a helmet or similar.

The see-through display device 100 further comprises a light engine (not shown) attached to the waveguide combiner 110. In the example of XR glasses or the like, the light engine may be embedded into a temple 102 of the glasses and covered by a frame 101 of the glasses. In certain embodiments, the see-through display device 100 comprises a respective waveguide combiner 110 for both eyes of a user.

FIG. 2 shows an example of the waveguide combiner 110 for one eye. The optical waveguide 140 of the waveguide combiner 110 receives light from the light engine (not shown) via a light in-coupling section 111. The light propagates within the optical waveguide 140 by total internal reflection and exits the optical waveguide 140 via the light out-coupling section 112 that preferably also comprises an exit pupil expander (EPE, not shown) conveniently expanding output light for a pupil of the eye of the user. In certain embodiments, the light in-coupling section 111 comprises an in-coupling grating (not shown in FIGS. 1 and 2). In certain embodiments, the light out-coupling section 112 comprises an out-coupling grating (not shown in FIGS. 1 and 2). In certain embodiments, the exit pupil expander is implemented by a third grating. In certain embodiments, the out-coupling grating and the exit pupil expander are combined into a single grating structure. The reference numeral 15 shows a frame cover borderline. As will be noted, the light in-coupling section 111 and the respective light engine in certain embodiments is covered by the frame (101, FIG. 1) of see-through display device 100.

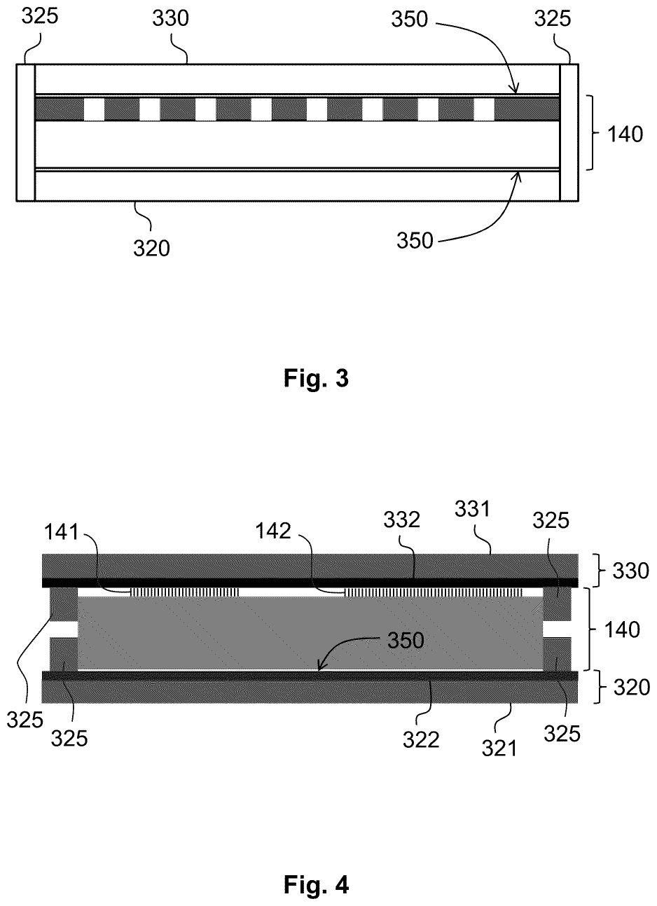

FIG. 3 shows a schematic cross-sectional view of an apparatus in accordance with certain embodiments. In certain embodiments, the apparatus forms a constructional part for the see-through display device 100. The apparatus comprises a first cover 320, a second cover 330 and an optical waveguide 140 attached in between the first cover 320 and the second cover 330. The waveguide 140 may be a diffractive waveguide of its type. The covers 320, 330 may be cover films. In certain embodiments, the waveguide 140 comprises a substrate, such as a glass substrate or a polymer substrate. In certain embodiments, the waveguide 140 comprises at least one grating on top of the substrate. At least the one of the first and second covers 320, 330 comprises a prescription lens in certain embodiments. In certain embodiments, at least one of the covers 320, 330 comprises at least one of a prescription lens, a dust-cover film, a dimming film, a push-pull addition.

The first cover 320 and the second cover 330 are in physical contact with the optical waveguide 140 at respective contact regions, but an air gap 350 is still maintained at said respective contact regions. The air gap 350 is maintained without a spacer (or spacers). In certain embodiments, the air gap 350 is maintained by the waveguide 140 and a respective (first or second) cover 320, 330 touching each other and by having air trapped between the parts. An optical contact between the parts is not formed and the parts therefore remain optically insulated without the need of any spacer(s). In certain embodiments, the waveguide 140 and the respective cover 320, 330 touch each other at the contact region with point-like contacts only. In certain embodiments, physical imperfections on the surface of the covers 320, 330 (causing the point-like contacts) are due to the manufacturing method(s) of the covers 320, 330.

FIG. 3 further shows that the interfaces between the waveguide 140 and the first and second cover 320, 330 are sealed along peripheral outlines of the optical waveguide 140 by a seal 325, such as a glue (e.g. high density glue) or an adhesive layer (or alternatively a sealing tape or film). In certain embodiments, the seal 325 on the side aids in maintaining the air gap 350. It prevents air from escaping from the air gap 350 during a subsequent manufacturing stage at which parts are fixed together, for example a molding or casting process. A further purpose of the seal 325 is to aid in preventing liquids or dust from penetrating in between the layers, especially in between the waveguide 140 and the covers 320, 330 (i.e., the air gap 350). In certain embodiments, the seal 325 is a hermetic seal.

FIG. 4 shows a more detailed schematic cross-sectional view of an apparatus in accordance with certain embodiments. In addition to the embodiments shown in FIG. 3, the embodiments shown in FIG. 4 show an anti-reflection coating 322 on the surface of a cover film 321 of the first cover 320, and an anti-reflection coating 332 on the surface of a cover film 331 of the second cover 330. The anti-reflective coatings 322, 332 of the first and second cover 320, 330 face towards the waveguide 140. Accordingly, in certain embodiments, the interface(s) between the anti-reflective coating(s) and waveguide is where the air gap 350 is formed. FIG. 4 further shows an in-coupling grating 141 and an out-coupling grating 142 of the waveguide 140. FIG. 4 further shows the seals 325 sealing the interfaces between the covers 320, 330 and the waveguide 140. Further, as mentioned in the preceding, at least one of the covers 320, 330 in certain embodiments comprises at least one of a prescription lens, a dust-cover film, a dimming film, a push-pull addition. These may be in addition to the layers shown in FIG. 4, or they may form part of the shown cover film 321, 331.

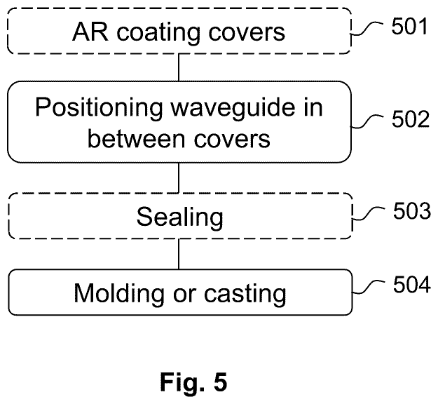

FIG. 5 shows a flow chart in accordance with certain embodiments of the present disclosure. In more detail, a method of assembling the described apparatus from parts is shown. The method comprises positioning the waveguide 140 in between the first cover 320 and the second cover 330 so that the first cover 320 and the second cover 330 are in physical contact with the optical waveguide 140 at respective contact regions, but an air gap 350 is still maintained at said respective contact regions by surface morphology (step 502). The method further comprises attaching (or fixing) the parts together by molding or casting (step 504).

In certain embodiments, the method comprises the optional step 501 prior to actually attaching the parts together, namely coating anti-reflection coatings 322, 332 onto respective surfaces of the first and second cover 320, 330. The first and second cover 320, 330 are placed with respect to the waveguide 140 so that the anti-reflection coating 322, 332 faces towards the optical 140.

In certain embodiments, the method further comprises sealing interfaces between the waveguide 140 and the first and second cover 320, 330 along peripheral outlines of the waveguide 140 in step 503 (prior to step 504).

In certain embodiments, an anti-reflection (AR) coated cover film (rigid enough so that it does not form an optical contact with the waveguide) is placed on both sides of the waveguide. AR coating is faced towards the waveguide. The interface between the waveguide and the cover film is sealed along the peripheral outline of the waveguide so that the air cannot escape from the space between the cover film and the waveguide. The refractive index of the cover film is matched with a casting or molding resin so that the cover film is fully invisible after molding/casting.

The proposed method is compatible with low pressure casting methods (e.g. no external pressure is applied when a mold is filled with the resin).

In certain embodiments, a touch-to-touch stack of the waveguide with additional layers (dust cover, prescription lens(es), dimming film, push-pull addition) is used as a manufacturing method or as a method of assembling a final device or apparatus. In certain embodiments, the method is used as a preparatory method for a low pressure casting or molding method.

Examples of applicable deposition methods for forming the anti-reflective coating are a wide range of chemical and physical deposition methods, such as CVD (chemical vapor deposition), PVD (physical vapor deposition), sputtering, or the like.

Without limiting the scope and interpretation of the patent claims, certain technical effects of one or more of the example embodiments disclosed herein are listed in the following. A technical effect is maintaining proper conditions for total internal reflection (TIR) and enabling maximization of the field of view (FOV). Another technical effect is to obtain this with more compact design. A further technical effect is to enable anti-reflective (AR) coatings within the device structure by coating the AR coatings first on the covers and then to merely stack the waveguide in between the covers and attach it. The interface between the optical insulator and the casted parts cannot be AR coated when using a conventional direct casting manufacturing method. Accordingly, a technical effect is to enable both the air gap and the AR coatings without a spacer by the disclosed two-step method, comprising first AR coating the covers and then attaching the AR coated covers and the waveguide together by casting or molding, preferably with a low pressure casting or molding method (without direct casting). A technical effect is thus providing the waveguide and the covers as a casted structure with the air gaps implemented and AR coatings implemented without spacers. Another technical effect is prevention of the formation of ghost images and interference rings due in ambient lighting. A further technical effect is avoidance of an artificial air gap altogether (conventionally obtained by spacers). A technical effect is formation of the required air gap between the waveguide and casted parts and formation of an AR coating between the optical insulator(s) (air gap(s)) and the casted part(s).

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means without deviating from the characteristics of the invention.

Furthermore, some of the features of the above-disclosed embodiments of this invention may be used to advantage without the corresponding use of other features. As such, the foregoing description should be considered as merely illustrative of the principles of the present invention, and not in limitation thereof. Hence, the scope of the invention is only restricted by the appended patent claims.

1. An apparatus for extended reality applications, comprising:
a first cover;
a second cover; and
an optical waveguide attached in between the first cover and the second cover, wherein the first cover and the second cover are in physical contact with the optical waveguide at respective contact regions, but an air gap is still maintained at said respective contact regions by surface morphology.

2. The apparatus of claim 1, wherein the air gap is arranged to optically insulate the optical waveguide from the first cover and from the second cover.

3. The apparatus of claim 1, wherein the first and/or second cover comprises an anti-reflection coating facing towards the optical waveguide.

4. The apparatus of claim 1, comprising an interface between the optical waveguide and the first and/or second cover sealed along a peripheral outline of the optical waveguide.

5. The apparatus of claim 4, wherein said sealing is realized by applying a glue or an adhesive.

6. The apparatus of claim 1, wherein the apparatus is assembled by molding or casting.

7. The apparatus of claim 6, comprising refractive index of casting resin matched with refractive index of the first and second cover.

8. The apparatus of claim 1, comprising an in-coupling grating at a light in-coupling section of the apparatus.

9. The apparatus of claim 1, further comprising a light out-coupling section and/or a light expanding section.

10. The apparatus of claim 1, the apparatus being a see-through display device.

11. A method of assembling the apparatus of claim 1 from parts, comprising:
positioning an optical waveguide in between a first cover and a second cover so that the first cover and the second cover are in physical contact with the optical waveguide at respective contact regions, but an air gap is still maintained at said respective contact regions by surface morphology; and
attaching parts together by molding or casting.

12. The method of claim 11, further comprising:
coating an anti-reflection coating onto a surface of the first and second cover; and
placing the first and second cover so that the anti-reflection coating faces towards the optical waveguide.

13. The method of claim 11, comprising:
sealing interfaces between the optical waveguide and the first and second cover along peripheral outlines of the optical waveguide prior to said molding or casting.

14. The apparatus of claim 1, wherein the first and/or second cover comprises an anti-reflection coating facing towards the optical waveguide.

15. The apparatus of claim 2, comprising an interface between the optical waveguide and the first and/or second cover sealed along a peripheral outline of the optical waveguide.

16. The apparatus of claim 3, comprising an interface between the optical waveguide and the first and/or second cover sealed along a peripheral outline of the optical waveguide.

17. The apparatus of claim 1, wherein the apparatus is assembled by low pressure casting.

18. The method of claim 12, comprising:
sealing interfaces between the optical waveguide and the first and second cover along peripheral outlines of the optical waveguide prior to said molding or casting.
